(19) United States
(12) Patent Application Publication
(10) Pub. No.: US 2026/0193036 A1
(43) Pub. Date: Jul. 9, 2026

(54) MODULAR BULK MATERIAL STORAGE STRUCTURE

(71) Applicant: Klun Frac Sand Solutions, Inc, Vernal, UT (US)

(72) Inventors: Lance Robert Klun, Vernal, UT (US); Brant John Klun, Vernal, UT (US); Garrett Anthony Klun, Vernal, UT (US)

(73) Assignee: Klun Frac Sand Solutions, Inc, Vernal, UT (US)

(21) Appl. No.: 19/015,434

(22) Filed: Jan. 9, 2025

(51) Int. Cl. B65G 1/04; B65G 65/32

(52) U.S. Cl. CPC B65G 1/0471; B65G 65/32; B65G 2201/04; B65G 2207/30

(57) ABSTRACT

A modular bulk materials storage structure may include a set of lower modules. The lower modules may include a first lower module to form a first partial funnel, a second lower module to form a second partial funnel, and a third lower module to form a third partial funnel. The lower modules may be joined to form a whole funnel. The storage structure may further include at least one set of middle modules. The middle modules may include a first middle module, a second middle module, a third middle module, and a fourth middle module. The middle modules may include walls that define at least a portion of a rectangular enclosure. The lower modules and the middle modules may be configured to join together to form at least a portion of a storage enclosure capable of storing and funneling bulk materials.

### FIELD OF THE DISCLOSURE

This disclosure is generally related to the field of bulk material storage at an industrial job site, or the like, and, in particular, to a modular bulk material storage structure.

### BACKGROUND

This disclosure is described with reference to the oil and gas industry, but may be equally applicable to any industry in which large volumes of bulk materials are stored, either temporarily or permanently, on-site, such as oil and gas, mining, farming, etc. The bulk materials herein are described with reference to frac sand and/or proppant, but the disclosure may be equally applicable to rocks, sand, concrete, vegetables, fruit, grains, seeds, plastic or wood pellets, other types of bulk materials, or the like. This disclosure is not to be construed as limited to only oil and gas applications.

Hydraulic fracturing is a method used in the oil and gas industry to release trapped oil and gas from the rock formation allowing it to flow into the casing and to the surface. The process involves pumping large volumes of water and sand down a well under high pressure. This highly pressurized slurry is pumped down the well casing through perforations into naturally occurring tiny fractures in shale formation. The high pressure from the fluid opens the naturally occurring fractures and creates new fractures. These fractures allow a pathway for the oil and gas to escape the formation and enter the casing through the perforations and then to the surface to be gathered. This process relies on a wide array of heavy equipment on-site at a well, including large hydraulic pumps, chemical storage equipment, proppant blender equipment, water storage vessels, and sand storage and handling equipment.

During the hydraulic fracturing completion process, it is often desirable for a tremendous amount of sand to be stored and handled on-site at a hydraulic fracturing well. Handling the sand in an efficient, environmentally friendly, cost effective, and safe way is challenging. Sand handling equipment and storage systems must be robust and reliable. Further, space may be limited at a job site, so it is desirable for storage systems in this industry to have a small footprint while still providing sufficient capacity for practical usage.

Typical storage systems for bulk materials include horizontal storage trailers, silos, storage boxes, or similar monolithic and permanent systems. In order to provide sufficient capacity, they may include multiple individual storage vessels to make up a complete system. Due to the volume of sand used for oil and gas extraction, these storage systems tend to be spread out, forming a large ground footprint and failing to utilize available air space. Further, they are only able to provide a small, often insufficient, amount of storage capacity.

Another shortcoming associated with typical storage systems is that, because equipment cannot be positioned underneath them, they typically rely on auxiliary equipment to transfer sand from the storage system to a desired point on-site. This auxiliary equipment requires more space on location and increases the risk of equipment failure that can negatively impact the efficiency of the job. In some cases, sand may be transferred up to three times in order to reach a hydraulic fracturing blender for use. This can render the entire process less efficient and requires additional equipment, which can impose higher costs to a contracting company for sand delivery, as well as increase the chance of equipment failure.

Other disadvantages may exist.

### SUMMARY

Disclosed is a modular bulk material storage structure that overcomes at least one of the shortcomings described above. The disclosed structure may alleviate storage capacity problems and may meet footprint requirements for stored material in various industries such as oil and gas, agriculture, mining, railroad, and other industries that may have the need for temporary or permanent storage of granular bulk material. The disclosed system requires no permanent foundation and may have a storage capacity of at least 35,000 cubic feet in one single structure. Further, the disclosed system is a modular design allowing it to be completely portable. The disclosed storage structure may have a discharge point that is elevated off the ground at a height of at least 13 feet, enabling a tractor trailer to drive completely under and through this structure. A tractor trailer, fracking blender, or any other equipment needed to be loaded from the structure may be positioned directly under the discharge gate, thereby eliminating the need for any additional transfer belts or other loading mechanisms. Further, due to its modularity, the disclosed storage structure may be customizable for different customers or industries. Other advantages may exist.

In an embodiment, a modular bulk materials storage structure includes a set of lower modules. The set of lower modules includes a first lower module that includes a first sloped surface, a second sloped surface, adjacent to the first sloped surface, and a third sloped surface, adjacent to the first sloped surface and positioned opposite to the second sloped surface. The first sloped surface, second sloped surface, and third sloped surface are joined to form a first partial funnel. The storage structure further includes a second lower module including a fourth sloped surface, a fifth sloped surface, adjacent to the fourth sloped surface, and a sixth sloped surface, adjacent to the fourth sloped surface and positioned opposite to the fifth sloped surface. The fourth sloped surface, fifth sloped surface, and sixth sloped surface are joined to form a second partial funnel. The first lower module and the second lower module are configured to combine to define at least a portion of a lower structural layer. The first partial funnel and the second partial funnel define at least a portion of a whole funnel within the lower structural layer.

In the embodiment, the storage structure includes at least one set of middle modules. The set of middle modules includes a first middle module that includes a first wall, a second wall, adjacent to the first wall, and a third wall, adjacent to the first wall and positioned parallel and opposite to the second wall. The set of middle modules further includes a second middle module that includes a fourth wall, a fifth wall, adjacent to the fourth wall, and a sixth wall, adjacent to the fourth wall and positioned parallel and opposite to the fifth wall. The first middle module and the second middle module are configured to combine to define at least a portion of a middle structural layer. The first wall, the second wall, the third wall, the fourth wall, the fifth wall, and the sixth wall define at least a portion of a rectangular enclosure within the portion of the middle structural layer. The lower structural layer and the middle structural layer are configured to join together to form at least a portion of a storage enclosure capable of storing and funneling bulk materials.

In some embodiments, the set of lower modules includes a third lower module that includes a seventh sloped surface, and an eighth sloped surface, positioned opposite the seventh sloped surface to form a third partial funnel. The first lower module, the second lower module, and the third lower module are configured to combine to define the lower structural layer. The third partial funnel defines at least another portion of the whole funnel within the lower structural layer.

In some embodiments, the set of middle modules include a third middle module that includes a seventh wall and a fourth middle module that includes an eighth wall. The first middle module, the second middle module, the third middle module, and the fourth middle module are configured to combine to define the portion of the middle structural layer. The seventh wall and the eighth wall define at least another portion of the rectangular enclosure within the portion of the middle structural layer.

In some embodiments, the structure includes two additional sets of middle modules. Each additional set of middle modules includes a first additional middle module that includes a first additional wall, a second additional wall, adjacent to the first additional wall, and a third additional wall, adjacent to the first additional wall and positioned parallel and opposite to the second additional wall. Each additional set of middle modules further includes a second additional middle module that includes a fourth additional wall, a fifth additional wall, adjacent to the fourth additional wall, and a sixth additional wall, adjacent to the fourth additional wall and positioned parallel and opposite to the fifth additional wall. Each additional set of middle modules also includes a third additional middle module including a seventh additional wall and a fourth additional middle module including an eighth additional wall. The first additional middle module, the second additional middle module, the third additional middle module, and the fourth additional middle module are configured to combine to define at least an additional portion of the middle structural layer. The first additional wall, the second additional wall, the third additional wall, the fourth additional wall, the fifth additional wall, the sixth additional wall, the seventh additional wall, and the eighth additional wall define an additional rectangular enclosure within the middle structural layer.

In some embodiments, the structure includes a set of bottom modules. The bottom modules include a first bottom module including a first set of supportive struts, a second bottom module including a second set of supportive struts, and a third bottom module including a platform. The first bottom module and the second bottom module are configured to adjoin the third bottom module opposite each other to define a bottom structural layer. The bottom structural layer is configured to join with the lower structural layer to support the storage enclosure.

In some embodiments, the bottom structural layer elevates the storage enclosure by at least 13 feet from the platform. In some embodiments, the bottom structural layer is configured to accommodate a tractor trailer or a fracking blender between the first set of supportive struts and the second set of supportive struts and below the storage enclosure. In some embodiments, the bottom structural layer is configured to support the storage enclosure without a physical foundation between the bottom structural layer and the ground.

In some embodiments, the structure includes a set of top modules. The set of top modules includes a first top module including a first top wall, a second top wall, adjacent to the first top wall, a third top wall, adjacent to the first top wall and positioned parallel and opposite to the second top wall, and a first roof adjacent to the first top wall, the second top wall, and the third top wall. The set of top modules further includes a second top module including a fourth top wall, a fifth top wall, adjacent to the fourth top wall, a sixth top wall, adjacent to the fourth top wall and positioned parallel and opposite to the fifth wall, and a second roof adjacent to the fourth top wall, the fifth top wall, and the sixth top wall. The set of top modules further includes a third top module including a seventh top wall, a fourth top module including an eighth top wall, and a fifth top module including a third roof. The first top module, the second top module, the third top module, the fourth top module, and the fifth top module are configured to combine to define a top structural layer. The top structural layer is configured to join with the middle structural layer and the lower structural layer to define the storage enclosure.

In some embodiments, at least one of the first roof, the second roof, and the third roof includes a hatch configured to enable loading of the storage enclosure by conveyor belt, bucket elevator, pneumatic conveyor, or a combination thereof. In some embodiments, the storage enclosure has a volume capacity of at least 35,000 cubic feet.

In an embodiment, a modular bulk materials storage assembly method includes assembling a lower structural layer on a bottom structural layer by: positioning a first lower module on the bottom structural layer, the first lower module including first sloped surfaces that form a first partial funnel; positioning a second lower module on the bottom structural layer, the second lower module including second sloped surfaces that form a second partial funnel; positioning a third lower module on the bottom structural layer, the third lower module including third sloped surfaces that form a third partial funnel; fastening the first lower module and the second lower module to the third lower module to form the lower structural layer, where the first partial funnel, the second partial funnel, and the third partial funnel define a whole funnel; and attaching the lower structural layer to the bottom structural layer.

The method further includes assembling a middle structural layer on the lower structural layer by: positioning a first middle module on the lower structural layer, the first middle module including a first wall, a second wall, adjacent to the first wall, and a third wall, adjacent to the first wall and positioned parallel and opposite to the second wall; positioning a second middle module on the lower structural layer, the second middle module including a fourth wall, a fifth wall, adjacent to the fourth wall, and a sixth wall, adjacent to the fourth wall and positioned parallel and opposite to the fifth wall; positioning a third middle module on the lower structural layer, the third middle module including a seventh wall; positioning a fourth middle module on the lower structural layer, the fourth middle module including an eighth wall; fastening the first middle module and the second middle module to the third middle module and the fourth middle module to define at least a portion of the middle structural layer, where the first wall, the second wall, the third wall, the fourth wall, the fifth wall, the sixth wall, the seventh wall, and the eighth wall define a rectangular enclosure within the middle structural layer; and attaching the middle structural layer to the lower structural layer to form at least a portion of a storage enclosure capable of storing and funneling bulk materials.

In some embodiments, the method includes further assembling the middle structural layer on the lower structural layer by: positioning a first additional middle module, the first additional middle module including a first additional wall, a second additional wall, adjacent to the first additional wall, and a third additional wall, adjacent to the first additional wall and positioned parallel and opposite to the second additional wall; positioning a second additional middle module, the second additional middle module including a fourth additional wall, a fifth additional wall, adjacent to the fourth additional wall, and a sixth additional wall, adjacent to the fourth additional wall and positioned parallel and opposite to the fifth additional wall; positioning a third additional middle module, the third additional middle module including a seventh additional wall; positioning a fourth additional middle module, the fourth additional middle module including an eighth additional wall; and fastening the first additional middle module and the second additional middle module to the third additional middle module and the fourth additional middle module to define at least an additional portion of the middle structural layer, where the first additional wall, the second additional wall, the third additional wall, the fourth additional wall, the fifth additional wall, the sixth additional wall, the seventh additional wall, and the eighth additional wall define an additional rectangular enclosure within the middle structural layer.

In some embodiments, the method includes assembling the bottom structural layer by: providing a first bottom module including a first set of supportive struts; providing a second bottom module including a second set of supportive struts; providing a third bottom module including a platform; and fastening the first bottom module and the second bottom module to the third bottom module to form the bottom structural layer, where the bottom structural layer is configured to support the storage enclosure.

### BRIEF DESCRIPTION OF THE DRAWINGS

FIG. 1 is an exploded perspective view of an embodiment of a modular bulk materials storage structure.

FIG. 2 is a perspective view of an embodiment of a module corresponding to a first and second lower module from a first angle.

FIG. 3 is a perspective view of the embodiment of the module of FIG. 2 from a second angle.

FIG. 4 is a perspective view of an embodiment of a module corresponding to a third lower module.

FIG. 5 is a perspective view of an embodiment of a lower structural layer.

FIG. 6 is a perspective view of an embodiment of a module corresponding to a first and second middle module of a first portion of a middle structural layer from a first angle.

FIG. 7 is a perspective view of the embodiment of the module of FIG. 6 from a second angle.

FIG. 8 is a perspective view of an embodiment of a module corresponding to a third middle module of the first portion of the middle structural layer.

FIG. 9 is a perspective view of an embodiment of a module corresponding to a fourth middle module of the first portion of the middle structural layer.

FIG. 10 is a perspective view of an embodiment of a first portion of a middle structural layer.

FIG. 11 is a perspective view of an embodiment of a module corresponding to a first and second middle module of a second portion of a middle structural layer from a first angle.

FIG. 12 is a perspective view of the embodiment of the module of FIG. 11 from a second angle.

FIG. 13 is a perspective view of an embodiment of a module corresponding to a third middle module of the second portion of the middle structural layer.

FIG. 14 is a perspective view of an embodiment of a module corresponding to a fourth middle module of the second portion of the middle structural layer.

FIG. 15 is a perspective view of an embodiment of a second portion of a middle structural layer.

FIG. 16 is a perspective view of an embodiment of a module corresponding to a first and second middle module of a third portion of a middle structural layer from a first angle.

FIG. 17 is a perspective view of the embodiment of the module of FIG. 16 from a second angle.

FIG. 18 is a perspective view of an embodiment of a module corresponding to a third middle module of the third portion of the middle structural layer.

FIG. 19 is a perspective view of an embodiment of a module corresponding to a fourth middle module of the third portion of the middle structural layer.

FIG. 20 is a perspective view of an embodiment of a third portion of a middle structural layer.

FIG. 21 is a perspective view of an embodiment of a module corresponding to a first and second top module of a top structural layer from a first angle.

FIG. 22 is a perspective view of the module of FIG. 21 from a second angle.

FIG. 23 is a perspective view of an embodiment of a module corresponding to a third top module.

FIG. 24 is a perspective view of an embodiment of a module corresponding to a fourth top module.

FIG. 25 is a perspective view of an embodiment of a module corresponding to a fifth top module.

FIG. 26 is a perspective view of an embodiment of a module corresponding to a top structural layer.

FIG. 27 is a perspective view of an embodiment of a module corresponding to a first and second bottom module.

FIG. 28 is a perspective view of the module of FIG. 27 from a second angle.

FIG. 29 is a perspective view of an embodiment of a module corresponding to a third bottom module.

FIG. 30 is a perspective view of an embodiment of a bottom structural layer.

FIG. 31 is a perspective view of an embodiment of a modular bulk materials storage structure.

FIGS. 32A-32D are a flow chart depicting an embodiment of a modular bulk materials storage assembly method.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the disclosure.

### DETAILED DESCRIPTION

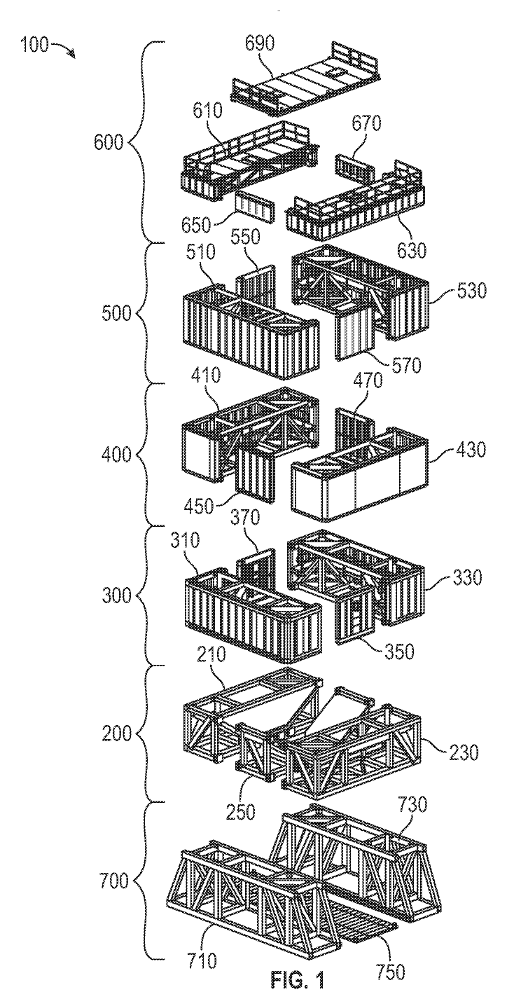

Referring to FIG. 1, a modular bulk materials storage structure 100 is depicted. The storage structure 100 may include a set of bottom modules 700, a set of lower structural modules 200, a set of middle modules 300, a first additional set of middle modules 400, a second additional set of middle modules 500, and a set of top modules 600. As used herein, the term “module” means a portion of a structure that unitary and, if constructed of multiple components, having components that are permanently and inseparably joined (e.g., welded, soldered, etc.). Modules may be joined non-permanently and separably to other modules (e.g., bolted, latched, etc.). The use of an adhesive or sealant between modules is not considered permanent for purposes of this disclosure.

The set of bottom modules 700 may include a first bottom module 710, a second bottom module 730, and a third bottom module 750. The set of lower modules 200 may include a first lower module 310, a second lower module 330, and a third lower module 350. The set of middle modules 300 may include a first middle module 310, a second middle module 330, a third middle module 350, and a fourth middle module 370. The first additional set of middle modules 400 may include a first additional middle module 410, a second additional middle module 430, a third additional middle module 450, and a fourth additional middle module 370. The second additional set of middle modules 500 may include a first other additional middle module 510, a second other additional middle module 530, a third other additional middle module 550, and a fourth other additional middle module 570. The set of top modules 600 may include a first top module 610, a second top module 630, a third top module 650, a fourth top module 670, and a fifth top module 690.

In operation, the structure 100 may be transported to a job site as individual modules and assembled onsite. The structure 100 may be temporary in that, when no longer needed, it may be disassembled back into individual modules and removed. Further, the structure may be customized (e.g., by adding or removing middle structural layers to increase or decrease capacity). In some embodiments, the capacity of the structure 100 may be at least 35,000 cubic feet. Further, individual modules may be repaired or replaced with no effect on other modules.

An advantage of the structure 100 is that more airspace above a jobsite may be utilized, thereby freeing space for other drilling operations and equipment. Further, the set of bottom modules 700 may elevate the lower structural layer by at least 13 feet to accommodate a tractor trailer, a fracking blender, other material transfer or drilling equipment, or the like, between the first bottom module 710 and the second bottom module 730. Also, the set of bottom modules 700 may provide sufficient support that a physical foundation between the set of bottom layers 700 and the ground may not be needed. Other advantages may exist.

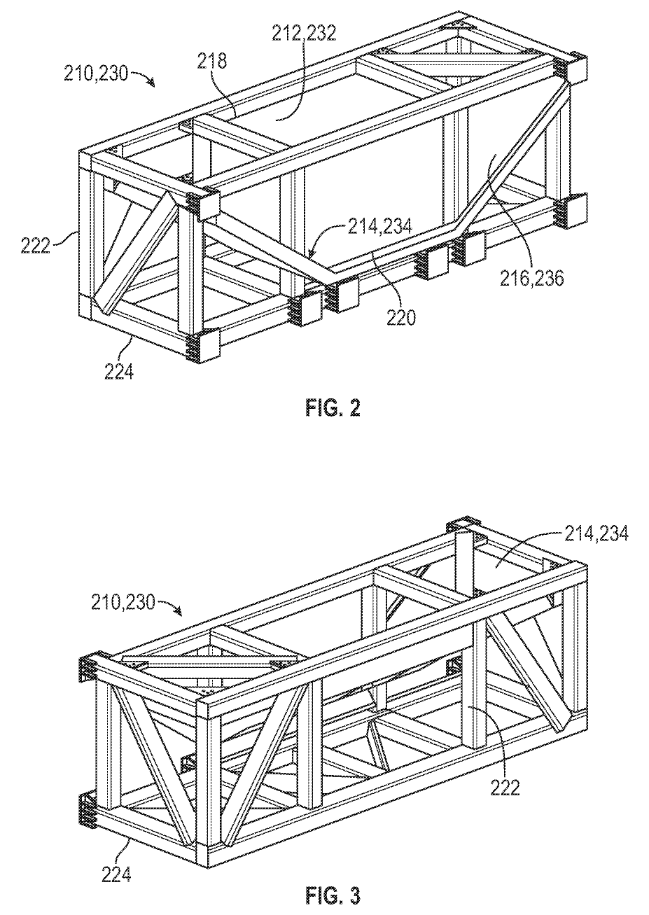

Referring to FIGS. 2 and 3, an embodiment of a first lower module 210 and a second lower module 230 is depicted. The first lower module 210 and the second lower module 230 may have a similar, or identical, structure. As such, in FIGS. 2 and 3, both the first lower module 210 and the second lower module 230 are described with reference to the same depictions, with the first reference numbers referring to the first lower module 210 and the second reference numbers referring to the second lower module 230.

The first lower module 210 may include a first sloped surface 212, a second sloped surface 214, and a third sloped surface 216. Likewise, the second lower module 210 may include a fourth sloped surface 232, a fifth sloped surface 234, and a sixth sloped surface 236. As visible in FIG. 2, the sloped surfaces 212, 214, 216, with respect to the first lower module 210, and the sloped surfaces 232, 234, 236, with respect to the second lower module 230, may run from an upper edge 218 to a lower edge 220 of the respective lower modules 210, 230.

In the first lower module 210, the second sloped surface 214 and the third sloped surface 216 may be positioned opposite from each other such that the sloped surfaces 212, 214, 216 of the first lower module 210 form a first portion of a geometric cone shape. Likewise, in the second lower module 230, the fifth sloped surface 234 and the sixth sloped surface 236 may be positioned opposite from each other such that the sloped surfaces 232, 234, 236 of the second lower module 210 form a second portion of the geometric cone shape or, in other words, a partial funnel. When put together, these portions of the geometric cone shape, along with other portions described further hererin, may form a funnel 204 (shown in FIG. 5).

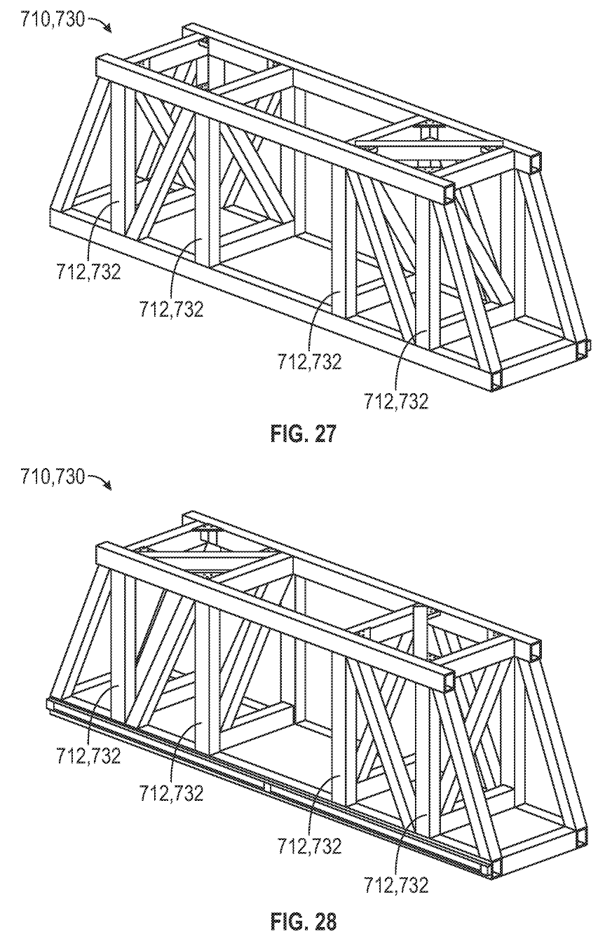

In both the first and second lower modules 210, 230, a system of struts 222 may provide support for the sloped surfaces 212, 214, 216 and 232, 234, 236 enabling them to withstand forces associated with holding and supporting bulk materials, such as sand and rocks. A level strut base 224 may enable the lower modules 210, 230 to be assembled with other modules on top of a bottom structural layer 702 (described further herein with respect to FIGS. 27-30).

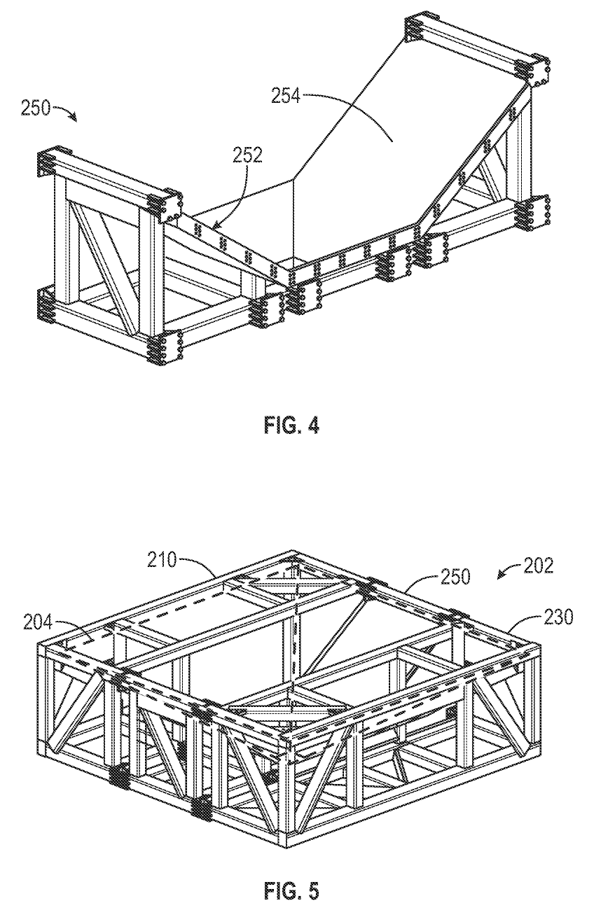

Referring to FIG. 4, an embodiment of a third lower module 250 is depicted. The third lower module 250 may include a seventh sloped surface 252 and an eighth sloped surface 254. These sloped surfaces 252, 254 may be positioned opposite each other to form a third portion of a geometric cone, or another partial funnel. The combination of the first, second, and third lower modules 210, 230, 250 may form the complete funnel 204 (shown in FIG. 5).

Referring to FIG. 5, an embodiment of a lower structural layer 202 is depicted, in which the lower modules 210, 230, 250 are assembled together. Each respective portion of the geometric cone formed by the lower modules 210, 230, 250, respectively, come together to form the funnel 204. The lower structural layer 202 may function as a hopper, holding bulk materials and funneling them for loading into equipment or vehicles positioned below the lower structural layer 202.

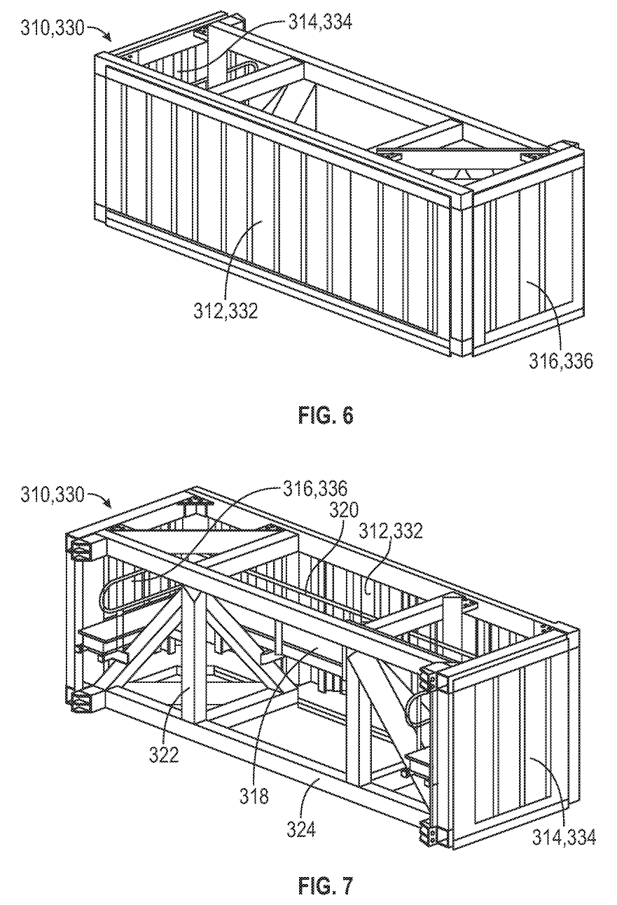

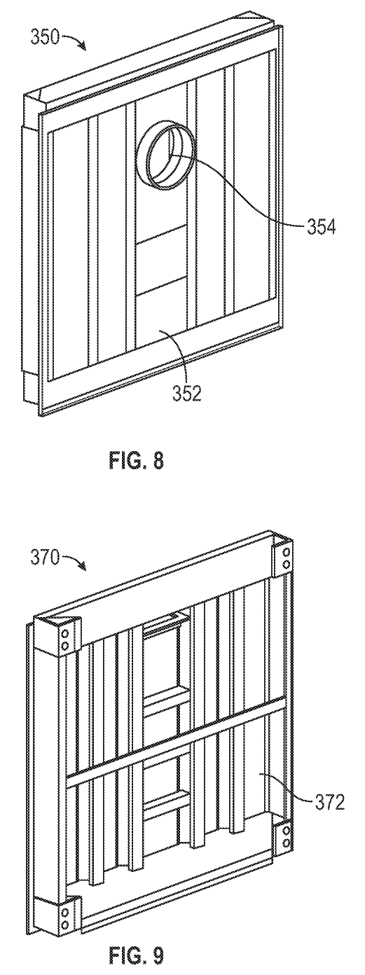

Referring to FIGS. 6 and 7, an embodiment of a first middle module 310 and a second middle module 330 is depicted. The first middle module 310 and the second middle module 330 may have a similar, or identical, structure. As such, in FIGS. 6 and 7, both the first middle module 310 and the second middle module 330 are described with reference to the same depictions, with the first reference numbers referring to the first middle module 310 and the second reference numbers referring to the second middle module 330.

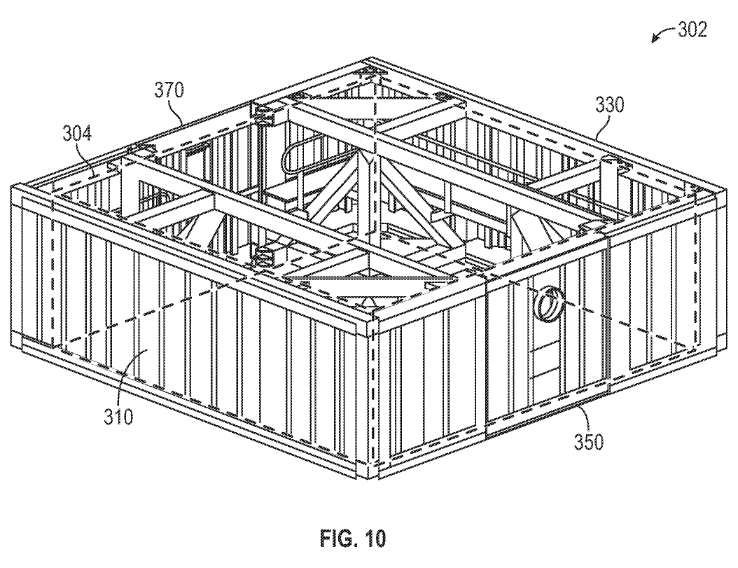

The first middle module 310 may include a first wall 312, a second wall 314, and a third wall 316. The walls 312, 314, 316 may be arranged in a “C” shape, with the second wall 314 and the third wall 316 both adjacent to the first wall 312 and positioned parallel and opposite each other. The second middle module 330 may, likewise, include a fourth fourth wall 332, a fifth wall 334, and a sixth wall 336. Similarly, the walls 332, 334, 336 may be arranged in a “C” shape, with the fifth wall 334 and the sixth wall 336 both adjacent to the fourth wall 332 and positioned parallel and opposite each other. The first middle module 310 and the second middle module 330 may be configured to combine, along with other modules as described herein, to define at least a portion 302 (shown in FIG. 10) of a middle structural layer 802 (shown in FIG. 31). Other portions of the middle structural layer 802 are described further herein.

The first middle module 310, the second middle module 330, or both may further include features to enable work to be done within the structure 100 when completed. For example, the first middle module 310, the second middle module 330, or any of the modules described herein may include a platform 318 for standing on during assembly and/or during operation. A guardrail 320 may also be included for safety.

Likewise, in both the first and second middle modules 310, 330, a system of struts 322 may provide support for the walls 312, 314, 316 and 332, 334, 336 enabling them to withstand forces associated with holding and supporting bulk materials, such as sand and rocks. A level strut base 324 may enable the middle modules 310, 330 to be assembled with other modules on top of the lower structural layer 202.

Referring to FIGS. 8 and 9, an embodiment of a third middle module 350 is depicted and an embodiment of a fourth middle module 370 is depicted. The third middle module 350 may include a seventh wall 352. The seventh wall 354 may include a window 354 defined therein. The window 354 may enable levels of bulk material to be monitored during use. The fourth middle module 170 may include an eighth wall 372.

Referring to FIG. 10, an embodiment of a first portion 302 of a middle structural layer 802 (shown in FIG. 31) is depicted. The first middle module 310, including the first wall 312, the second wall 314, the third wall 316 (shown in FIGS. 6 and 7), the second middle module, including the fourth wall 332, the fifth wall 334, and the sixth wall 334 (also shown in FIGS. 6 and 7), the third middle module 350, including the seventh wall 352, and the fourth middle module 370, including the eighth wall 372 may be combined together to define at least a portion of a rectangular enclosure 304 within the portion 302 of the middle structural layer 802 (shown in FIG. 31). The middle structural layer 802 may function, in cooperation with other layers, as a container for holding bulk materials.

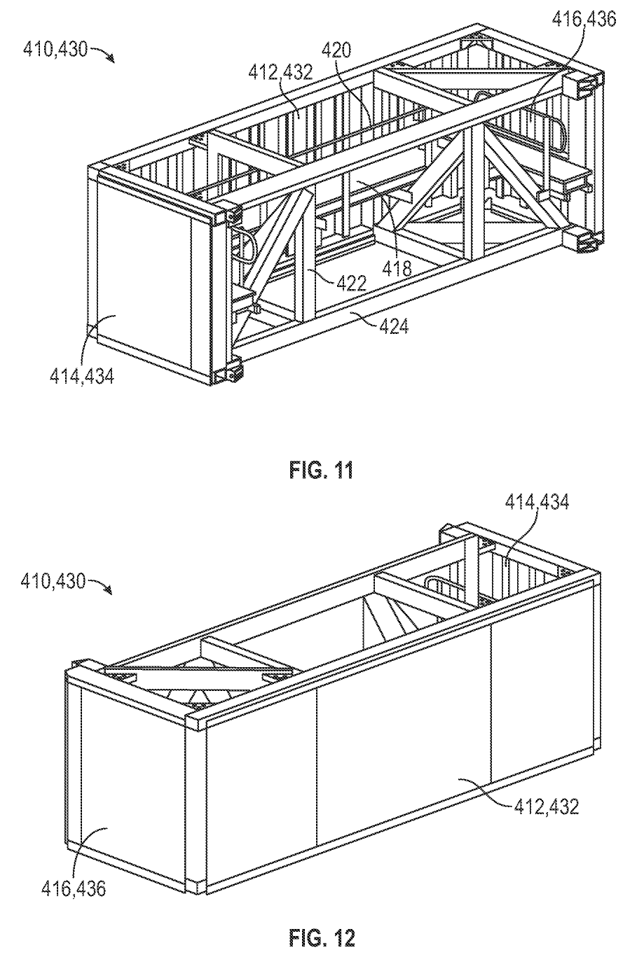

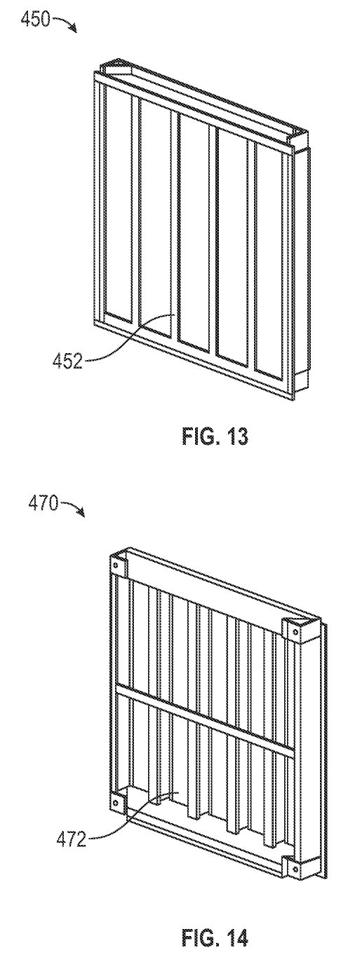

Referring to FIGS. 11 and 12, an embodiment of a first additional middle module 410 and a second additional middle module 430 is depicted. The first additional middle module 410 and the second additional middle module 430 may have a similar, or identical, structure. As such, in FIGS. 11 and 12, both the first additional middle module 410 and the second additional middle module 430 are described with reference to the same depictions, with the first reference numbers referring to the first additional middle module 410 and the second reference numbers referring to the second additional middle module 430.

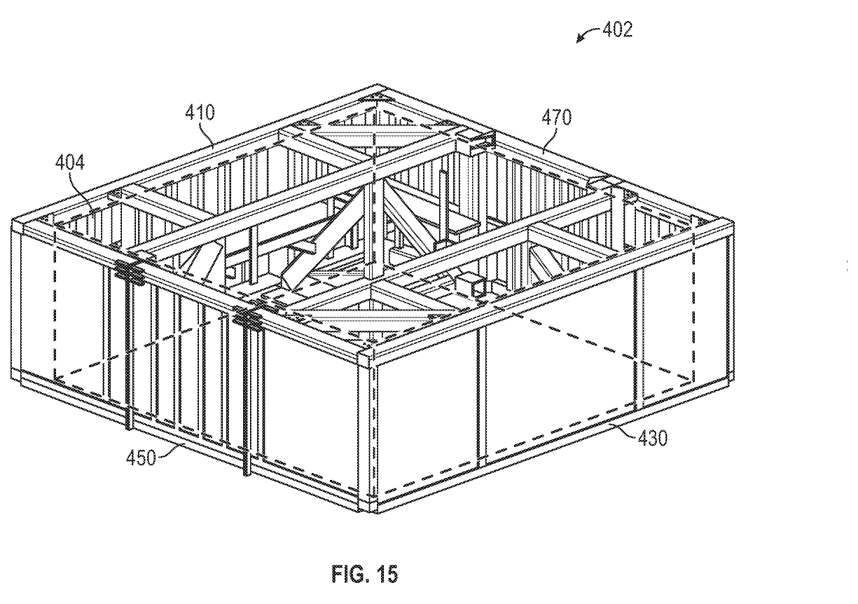

The first additional middle module 410 may include a first additional wall 412, a second additional wall 414, and a third additional wall 416. The additional walls 412, 414, 416 may be arranged in a “C” shape, with the second additional wall 414 and the third additional wall 416 both adjacent to the first additional wall 412 and positioned parallel and opposite each other. The second additional middle module 430 may, likewise, include a fourth additional wall 432, a fifth additional wall 434, and a sixth additional wall 436. Similarly, the additional walls 432, 434, 436 may be arranged in a “C” shape, with the fifth additional wall 434 and the sixth additional wall 436 both adjacent to the fourth additional wall 432 and positioned parallel and opposite each other. The first additional middle module 410 and the second additional middle module 430 may be configured to combine, along with other modules as described herein, to define at least an additional portion 402 (shown in FIG. 15) of the middle structural layer 802 (shown in FIG. 31). Other portions of the middle structural layer 802 are described further herein.

The first additional middle module 410, the second additional middle module 430, or both may further include features to enable work to be done within the structure 100 when completed. For example, the first additional middle module 410, the second additional middle module 430, or any of the modules described herein may include a platform 418 for standing on during assembly and/or during operation. A guardrail 420 may also be included for safety.

Likewise, in both the first and second additional middle modules 410, 430, a system of struts 422 may provide support for the additional walls 412, 414, 416 and 432, 434, 436 enabling them to withstand forces associated with holding and supporting bulk materials, such as sand and rocks. A level strut base 424 may enable the additional middle modules 410, 430 to be assembled with other modules on top of the first portion 302 of the middle structural layer 802.

Referring to FIGS. 13 and 14, an embodiment of a third additional middle module 450 is depicted and an embodiment of a fourth additional middle module 470 is depicted. The third additional middle module 450 may include an additional seventh wall 452. The fourth additional middle module 470 may include an eighth additional wall 472.

Referring to FIG. 15, an embodiment of a second portion 402 of a middle structural layer 802 (shown in FIG. 31) is depicted. The first additional middle module 410, including the first additional wall 412, the second additional wall 414, the third additional wall 416 (shown in FIGS. 11 and 12), the second additional middle module 430, including the fourth additional wall 432, the fifth additional wall 434, and the sixth additional wall 434 (also shown in FIGS. 11 and 12), the third middle module 450, including the seventh wall 452, and the fourth middle module 470, including the eighth wall 472 may be combined together to define at least a portion of a rectangular enclosure 404 within the portion 402 of the middle structural layer 802 (shown in FIG. 31). As described herein, the middle structural layer 802 may function, in cooperation with other layers, as a container for holding bulk materials.

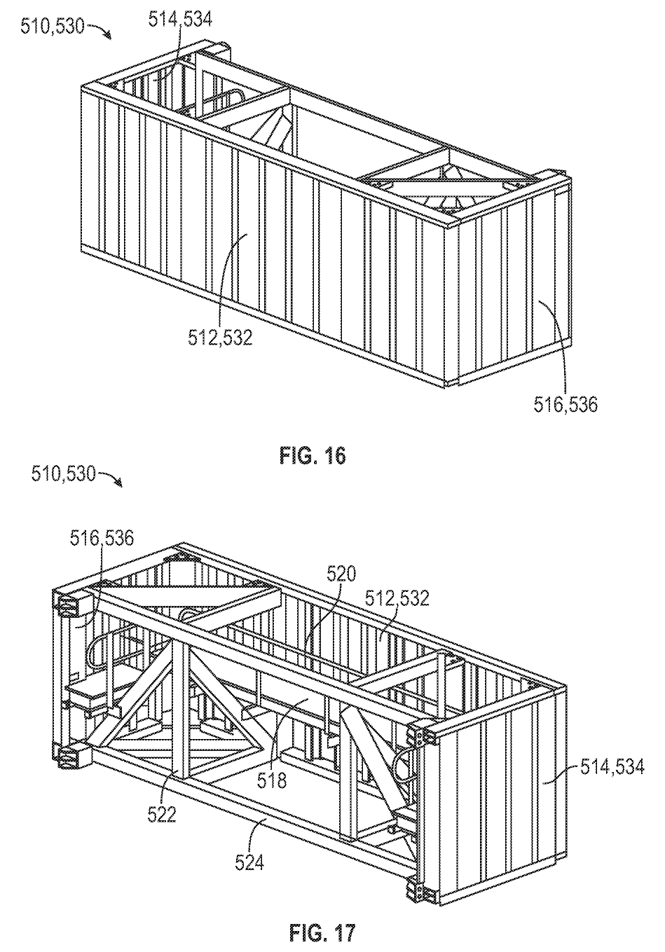

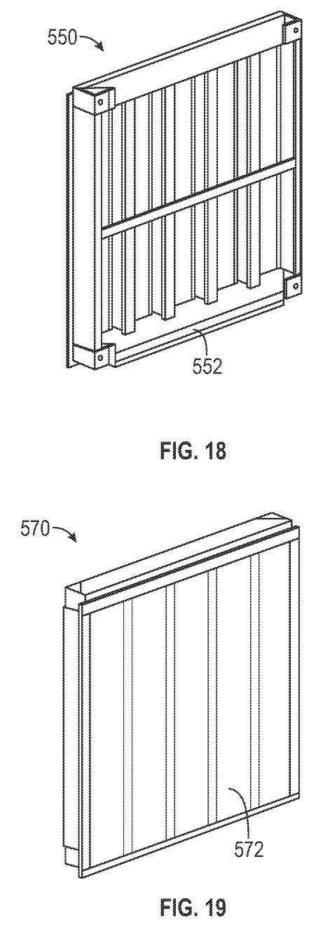

Referring to FIGS. 16 and 17, an embodiment of a first other additional middle module 510 and a second other additional middle module 530 is depicted. The first other additional middle module 510 and the second other additional middle module 530 may have a similar, or identical, structure. As such, in FIGS. 16 and 17, both the first other additional middle module 510 and the second other additional middle module 530 are described with reference to the same depictions, with the first reference numbers referring to the first other additional middle module 510 and the second reference numbers referring to the second other additional middle module 530.

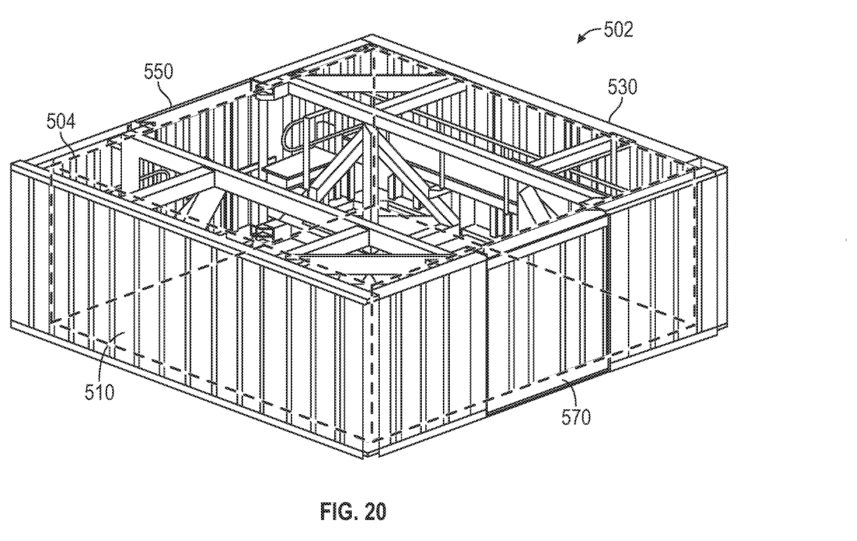

The first other additional middle module 510 may include a first other additional wall 512, a second other additional wall 514, and a third other additional wall 516. The other additional walls 512, 514, 516 may be arranged in a “C” shape, with the second other additional wall 514 and the third other additional wall 516 both adjacent to the first other additional wall 512 and positioned parallel and opposite each other. The second other additional middle module 530 may, likewise, include a fourth other additional wall 532, a fifth other additional wall 534, and a sixth other additional wall 536. Similarly, the other additional walls 532, 534, 536 may be arranged in a “C” shape, with the fifth other additional wall 534 and the sixth other additional wall 536 both adjacent to the fourth other additional wall 532 and positioned parallel and opposite each other. The first other additional middle module 510 and the second other additional middle module 530 may be configured to combine, along with other modules as described herein, to define at least another additional portion 502 (shown in FIG. 20) of the middle structural layer 802 (shown in FIG. 31).

The first other additional middle module 510, the second other additional middle module 530, or both may further include features to enable work to be done within the structure 100 when completed. For example, the first other additional middle module 510, the second other additional middle module 530, or any of the modules described herein may include a platform 518 for standing on during assembly and/or during operation. A guardrail 520 may also be included for safety.

Likewise, in both the first and second other additional middle modules 510, 530, a system of struts 522 may provide support for the other additional walls 512, 514, 516 and 532, 534, 536 enabling them to withstand forces associated with holding and supporting bulk materials, such as sand and rocks. A level strut base 524 may enable the other additional middle modules 510, 530 to be assembled with other modules on top of the second portion 402 of the middle structural layer 802.

Referring to FIGS. 18 and 19, an embodiment of a third other additional middle module 550 is depicted and an embodiment of a fourth other additional middle module 570 is depicted. The third other additional middle module 550 may include another additional seventh wall 552. The fourth other additional middle module 570 may include another additional eighth wall 572.

Referring to FIG. 20, an embodiment of a third portion 502 of a middle structural layer 802 (shown in FIG. 31) is depicted. The first other additional middle module 510, including the first other additional wall 512, the second other additional wall 514, the third other additional wall 516 (shown in FIGS. 16 and 17), the second other additional middle module 530, including the fourth other additional wall 532, the fifth other additional wall 534, and the sixth other additional wall 534 (also shown in FIGS. 16 and 17), the third other additional middle module 550, including the seventh other additional wall 552, and the fourth other additional middle module 570, including the eighth other additional wall 572 may be combined together to define at least a portion of another additional rectangular enclosure 504 within the portion 502 of the middle structural layer 802 (shown in FIG. 31). The middle structural layer 802 may function, in cooperation with other layers, as a container for holding bulk materials.

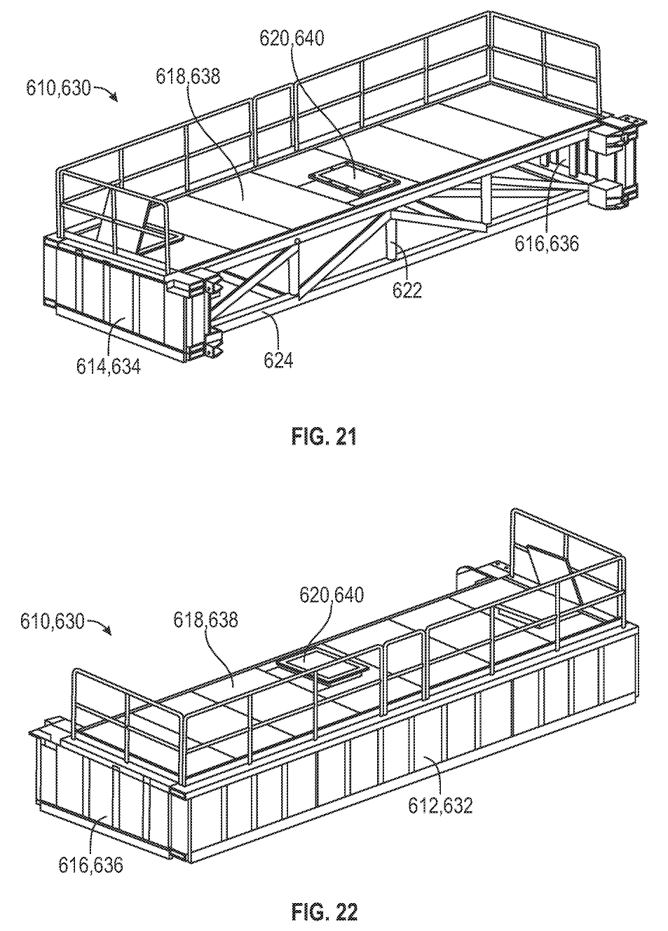

Referring to FIGS. 21 and 22, an embodiment of a first top module 610 and a second top module 630 is depicted. The first top module 610 and the second top module 630 may have a similar, or identical, structure. As such, in FIGS. 21 and 22, both the first top module 610 and the second top module 630 are described with reference to the same depictions, with the first reference numbers referring to the first top module 610 and the second reference numbers referring to the second top module 630.

The first top module 610 may include a first top wall 612, a second top wall 614, and a third top wall 616. The top walls 612, 614, 616 may be arranged in a “C” shape, with the second top wall 614 and the third top wall 616 both adjacent to the first top wall 612 and positioned parallel and opposite each other. The first top module 610 may further include a first roof 618 adjacent to each of the top walls 612, 614, 616. The first roof 618 may include a first hatch 620.

The second top module 630 may, likewise, include a fourth top wall 632, a fifth top wall 634, and a sixth top wall 636. Similarly, the top walls 632, 634, 636 may be arranged in a “C” shape, with the fifth top wall 634 and the sixth top wall 636 both adjacent to the fourth top wall 632 and positioned parallel and opposite each other. The second top module 630 may further include a second roof 638 adjacent to each of the top walls 632, 634, 636. The second roof 638 may include a second hatch 640.

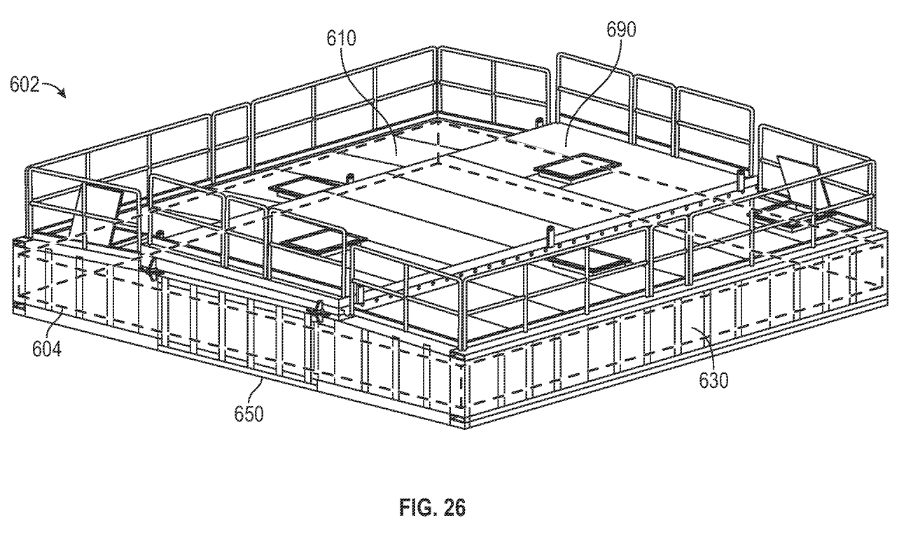

The first top module 610 and the second top module 630 may be configured to combine to define at least a portion of a top structural layer 602 (shown in FIG. 26). The first and second top modules 610, 630 may be configured to combine, along with other modules as described herein, to define at least a portion of a top structural layer 602 (shown in FIG. 31).

In both the first and second top modules 610, 630, a system of struts 622 may provide support. A level strut base 624 may enable the top modules 610, 630 to be assembled with other modules on top of the middle structural layer 802.

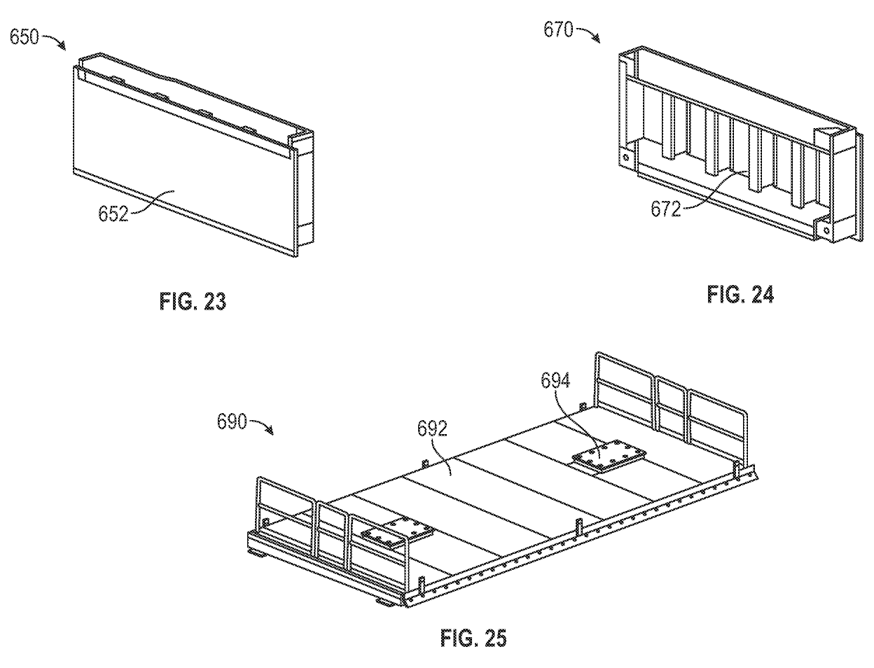

Referring to FIGS. 23 and 24, an embodiment of a third top module 650 is depicted and an embodiment of a fourth top module 670 is depicted. The third top module 650 may include a seventh top wall 652.The fourth top module 670 may include an eighth top wall 672. Referring to FIG. 25, an embodiment of a fifth top module 690 is depicted. The fifth top module 690 may include a third roof 692 and a third hatch 694.

Referring to FIG. 26, an embodiment of a top structural layer 602 is depicted. The first top module 610, the second top module 630, the third top module 650, the fourth top module 670, and the fifth top module 690 may be combined together to define a top rectangular enclosure 604 within top structural layer 602. The top structural layer 602 may function, in cooperation with other layers, as a container for holding bulk materials.

Referring to FIGS. 27 and 28, an embodiment of a first bottom module 710 and a second bottom module 730 is depicted. The first bottom module 710 and the second bottom module 730 may have a similar, or identical, structure. As such, in FIGS. 27 and 28, both the first bottom module 710 and the second bottom module 730 are described with reference to the same depictions, with the first reference numbers referring to the first bottom module 710 and the second reference numbers referring to the second bottom module 730.

The first bottom module 710 may include a first system of bottom struts 712. The second bottom module 730 may include a second system of bottom struts 732. The first and second bottom modules 710, 730 may provide a sufficient base to support the structure 100 without assistance from a foundation.

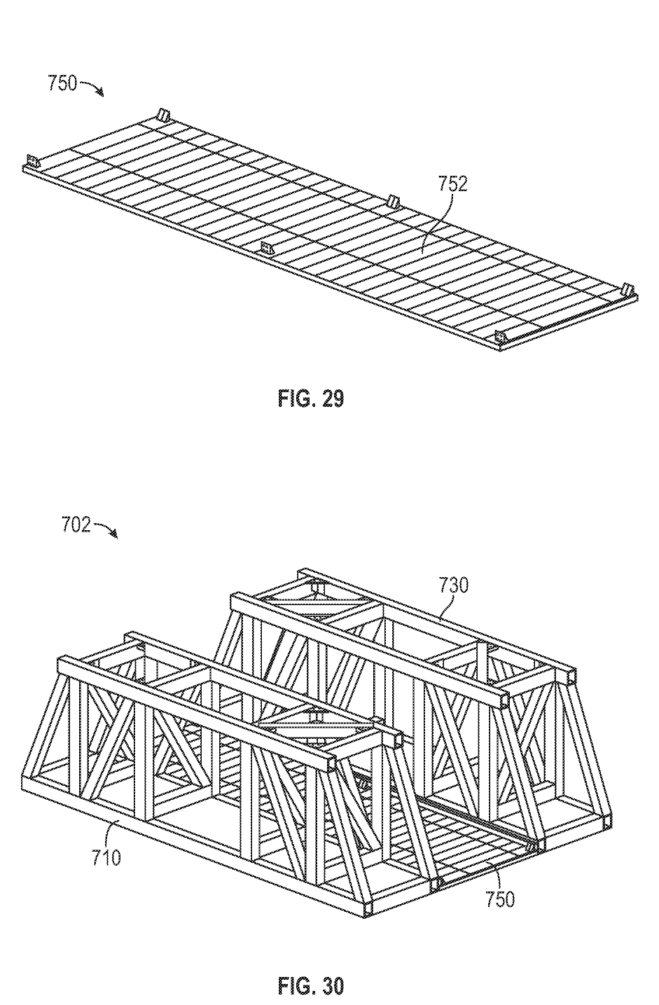

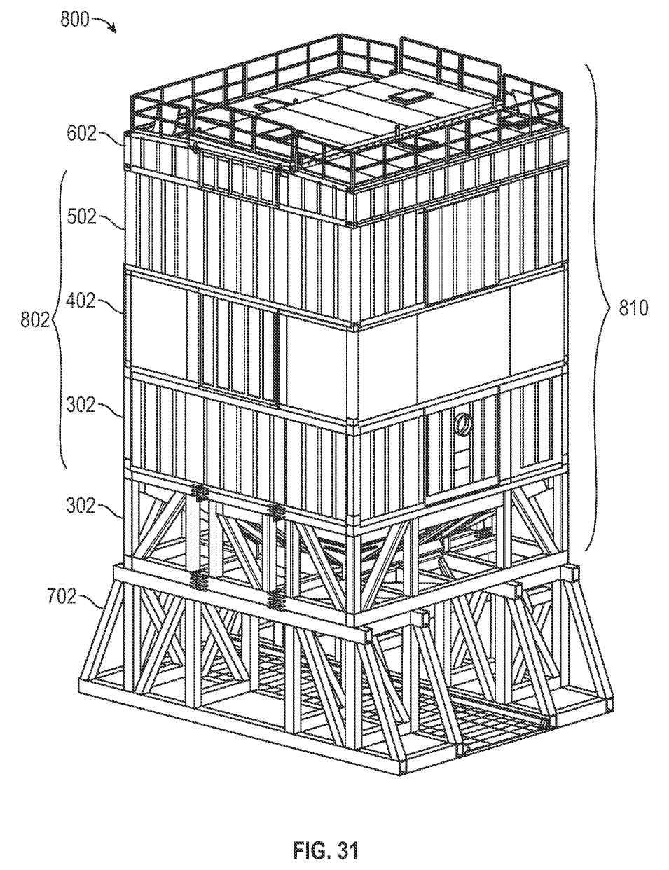

Referring to FIG. 29, an embodiment of a third bottom module 750 is depicted. The third bottom module 750 may include a platform 752. The first bottom module 710 and the second bottom module 730 may be configured to adjoin the third bottom module 750 opposite each other to define a bottom structural layer 702. Referring to FIG. 30, an embodiment of a bottom structural layer 702 is depicted.

Referring to FIG. 31, an embodiment of an assembly 800 is depicted. The assembly corresponds to the structure 100. The assembly 800 may include a bottom structural layer 702, a lower structural layer 202, a middle structural layer 802, and a top structural layer 602. The middle structural layer 802 may include a first portion 302, a second portion 402, and a third portion 502. The lower structural layer 202, the middle structural layer 802 and the top structural layer 602 may form a storage enclosure 810. The storage enclosure 810 may be usable to store fracking sand, rocks, or other bulk materials as described herein.

The bottom structural layer 702 may elevate the enclosure 810 by at least 13 feet from the bottom (e.g., the platform) of the bottom structural layer 702. By doing so, the bottom structural layer 702 may be configured to accommodate a tractor trailer or a fracking blender below the storage enclosure 810. The bottom structural layer 702 may be configured to support the storage enclosure 810 without a physical foundation between the bottom structural layer and the ground. Further, the top structural layer may be configured to enable loading of the storage enclosure 810 by conveyor belt, bucket elevator, pneumatic conveyor, or a combination thereof through respective hatches.

A benefit of the assembly 800 is that the storage enclosure 810 may have a volume capacity of at least 35,000 cubic feet, which is more than typical silos or other types of enclosures in use. Further, the modular design enables the assembly 800 to be used as a temporary or permanent structure. In some cases, it may be disassembled, relocated, and reassembled. As explained herein, other advantages and benefits exist.

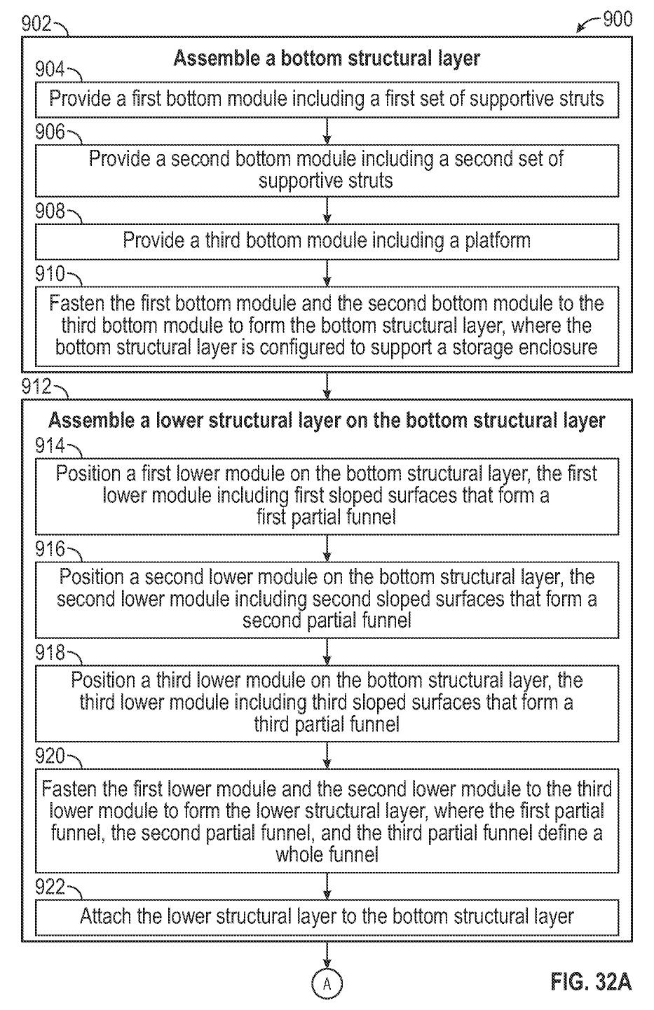

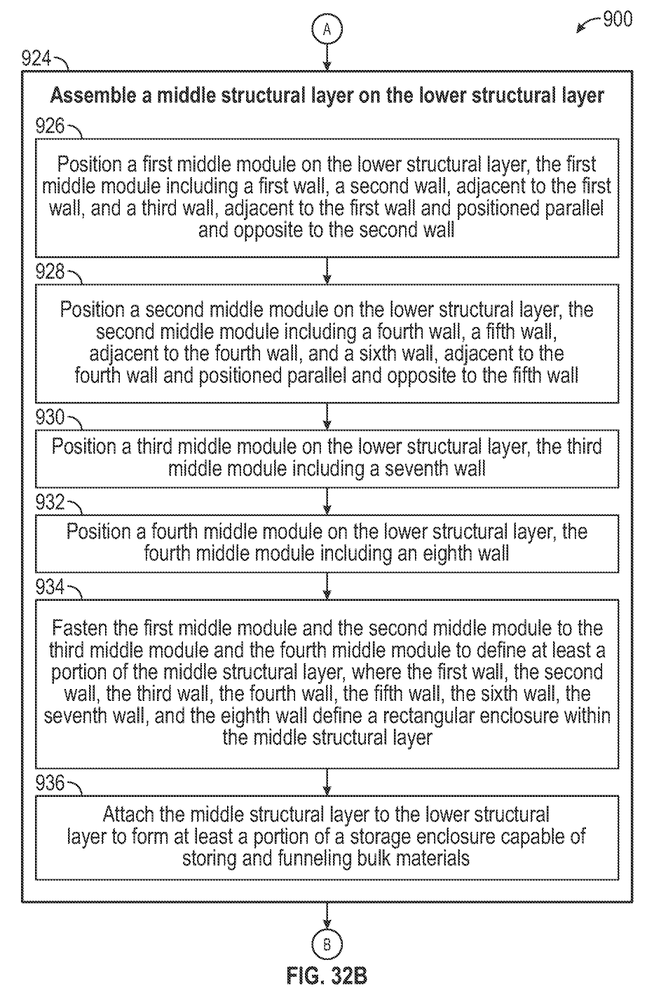

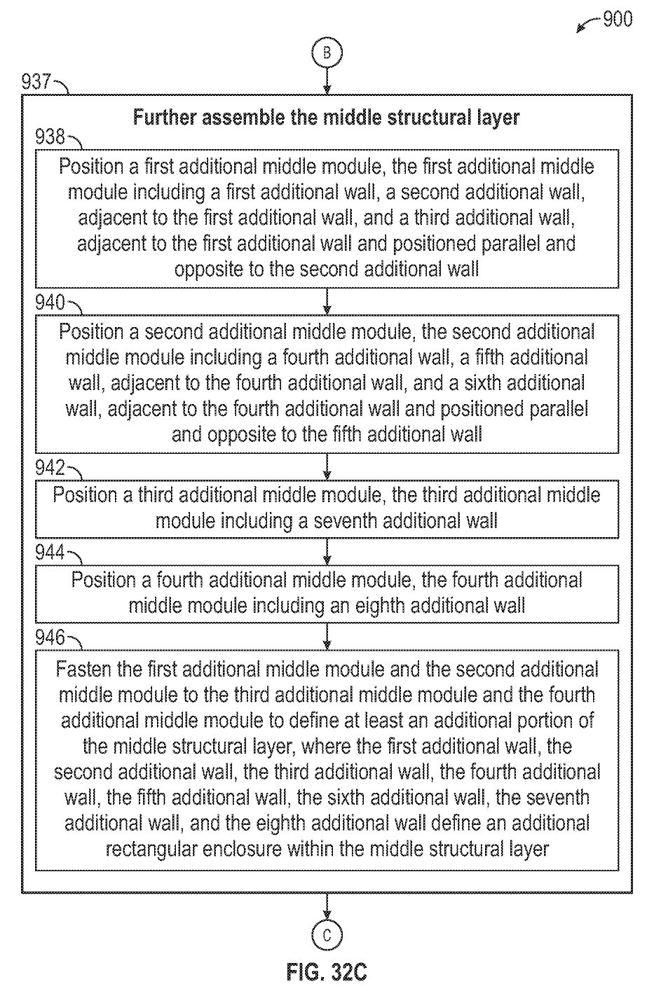

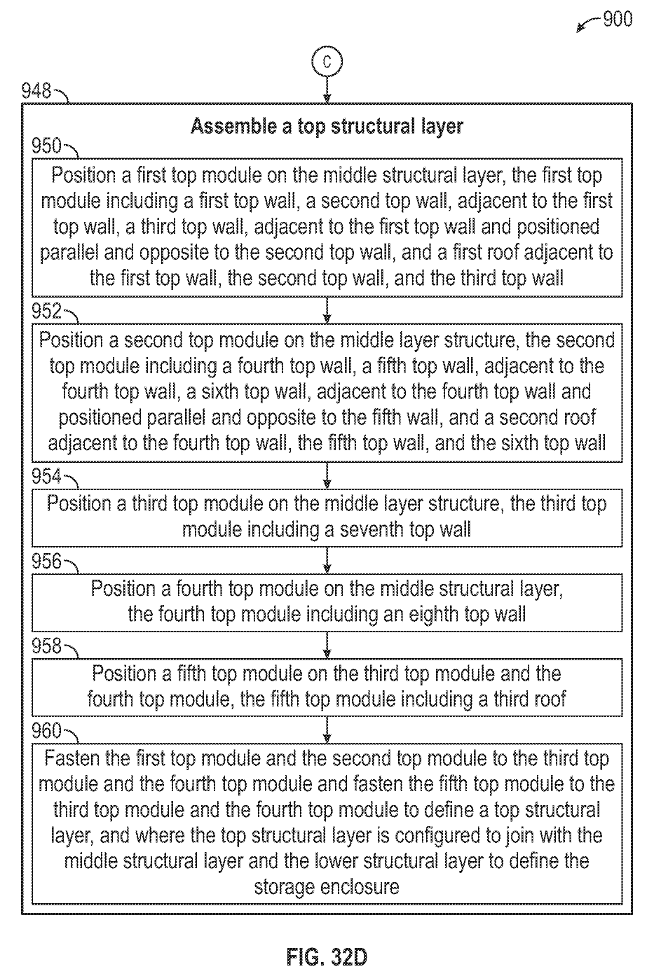

Referring to FIG. 32, a modular bulk materials storage assembly method 900 is depicted. The method 900 may include assembling a bottom structural layer, at 902. For example, the bottom structural layer 702 may be assembled. Assembling the bottom structural layer may include providing a first bottom module including a first set of supportive struts, at 904. Assembling the bottom structural layer may further include providing a second bottom module including a second set of supportive struts, at 906. Assembling the bottom structural layer may also include providing a third bottom module including a platform, at 908. Assembling the bottom structural layer may include fastening the first bottom module and the second bottom module to the third bottom module to form the bottom structural layer, where the bottom structural layer is configured to support a storage enclosure, at 910.

The method 900 may further include assembling a lower structural layer on the bottom structural layer, at 912. For example, the lower structural layer 202 may be assembled. Assembling the lower structural layer may include positioning a first lower module on the bottom structural layer, the first lower module including first sloped surfaces that form a first partial funnel, at 914. Assembling the lower structural layer may further include positioning a second lower module on the bottom structural layer, the second lower module including second sloped surfaces that form a second partial funnel, at 916. Assembling the lower structural layer may also include positioning a third lower module on the bottom structural layer, the third lower module including third sloped surfaces that form a third partial funnel, at 918. Assembling the lower structural layer may include fastening the first lower module and the second lower module to the third lower module to form the lower structural layer, where the first partial funnel, the second partial funnel, and the third partial funnel define a whole funnel, at 920. Assembling the lower structural layer may further include attaching the lower structural layer to the bottom structural layer, at 922.

The method 900 may also include assembling a middle structural layer on the lower structural layer, at 924. For example, the middle structural layer 802 may be assembled. Assembling the middle structural layer may include positioning a first middle module on the lower structural layer, the first middle module including a first wall, a second wall, adjacent to the first wall, and a third wall, adjacent to the first wall and positioned parallel and opposite to the second wall, at 926. Assembling the middle structural layer may further include positioning a second middle module on the lower structural layer, the second middle module including a fourth wall, a fifth wall, adjacent to the fourth wall, and a sixth wall, adjacent to the fourth wall and positioned parallel and opposite to the fifth wall, at 928. Assembling the middle structural layer may also include positioning a third middle module on the lower structural layer, the third middle module including a seventh wall, at 930. Assembling the middle structural layer may include positioning a fourth middle module on the lower structural layer, the fourth middle module including an eighth wall, at 932. Assembling the middle structural layer may further include fastening the first middle module and the second middle module to the third middle module and the fourth middle module to define at least a portion of the middle structural layer, where the first wall, the second wall, the third wall, the fourth wall, the fifth wall, the sixth wall, the seventh wall, and the eighth wall define a rectangular enclosure within the middle structural layer, at 934. Assembling the middle structural layer may also include attaching the middle structural layer to the lower structural layer to form at least a portion of a storage enclosure capable of storing and funneling bulk materials, at 936.

The method 900 may include further assembling the middle structural layer, at 937, by positioning a first additional middle module, the first additional middle module including a first additional wall, a second additional wall, adjacent to the first additional wall, and a third additional wall, adjacent to the first additional wall and positioned parallel and opposite to the second additional wall, at 938. Further assembling the middle structural layer may further include positioning a second additional middle module, the second additional middle module including a fourth additional wall, a fifth additional wall, adjacent to the fourth additional wall, and a sixth additional wall, adjacent to the fourth additional wall and positioned parallel and opposite to the fifth additional wall, at 940. Further assembling the middle structural layer may also include positioning a third additional middle module, the third additional middle module including a seventh additional wall, at 942. Further assembling the middle structural layer may include positioning a fourth additional middle module, the fourth additional middle module including an eighth additional wall, at 944. Further assembling the middle structural layer may further include fastening the first additional middle module and the second additional middle module to the third additional middle module and the fourth additional middle module to define at least an additional portion of the middle structural layer, where the first additional wall, the second additional wall, the third additional wall, the fourth additional wall, the fifth additional wall, the sixth additional wall, the seventh additional wall, and the eighth additional wall define an additional rectangular enclosure within the middle structural layer, at 946.

The method 900 may further include assembling a top structural layer, at 948. For example, the top structural layer 602 may be assembled. Assembling the top structural layer may include positioning a first top module on the middle structural layer, the first top module including a first top wall, a second top wall, adjacent to the first top wall, a third top wall, adjacent to the first top wall and positioned parallel and opposite to the second top wall, and a first roof adjacent to the first top wall, the second top wall, and the third top wall, at 950. Assembling the top structural layer may further include positioning a second top module on the middle layer structure, the second top module including a fourth top wall, a fifth top wall, adjacent to the fourth top wall, a sixth top wall, adjacent to the fourth top wall and positioned parallel and opposite to the fifth wall, and a second roof adjacent to the fourth top wall, the fifth top wall, and the sixth top wall, at 952. Assembling the top structural layer may also include positioning a third top module on the middle layer structure, the third top module including a seventh top wall, at 954. Assembling the top structural layer may include positioning a fourth top module on the middle structural layer, the fourth top module including an eighth top wall, at 956. Assembling the top structural layer may further include positioning a fifth top module on the third top module and the fourth top module, the fifth top module including a third roof, at 958. Assembling the top structural layer may also include fastening the first top module and the second top module to the third top module and the fourth top module and fastening the fifth top module to the third top module and the fourth top module to define a top structural layer, and where the top structural layer is configured to join with the middle structural layer and the lower structural layer to define the storage enclosure, at 960.

Although various embodiments have been shown and described, the present disclosure is not so limited and will be understood to include all such modifications and variations as would be apparent to one skilled in the art.

What is claimed is:

1. A modular bulk materials storage structure (100) comprising:
a set of lower modules (200) comprising:
a first lower module (210) comprising a first sloped surface (212), a second sloped surface (214), adjacent to the first sloped surface (212), and a third sloped surface (216), adjacent to the first sloped surface (212) and positioned opposite to the second sloped surface (214), the first sloped surface (212), second sloped surface (214), and third sloped surface (216) joined to form a first partial funnel; and
a second lower module (230) comprising a fourth sloped surface (232), a fifth sloped surface (234), adjacent to the fourth sloped surface (232), and a sixth sloped surface (236), adjacent to the fourth sloped surface (232) and positioned opposite to the fifth sloped surface (234), the fourth sloped surface (232), fifth sloped surface (234), and sixth sloped surface (236) joined to form a second partial funnel,
wherein the first lower module (210) and the second lower module (230) are configured to combine to define at least a portion of a lower structural layer (202), and wherein the first partial funnel and the second partial funnel define at least a portion of a whole funnel (204) within the lower structural layer (202); and
at least one set of middle modules (300) comprising:
a first middle module (310) comprising a first wall (312), a second wall (314), adjacent to the first wall (312), and a third wall (316), adjacent to the first wall (312) and positioned parallel and opposite to the second wall (314); and
a second middle module (330) comprising a fourth wall (332), a fifth wall (334), adjacent to the fourth wall (332), and a sixth wall (336), adjacent to the fourth wall (332) and positioned parallel and opposite to the fifth wall (334),
wherein the first middle module (310) and the second middle module (330) are configured to combine to define at least a portion (302) of a middle structural layer (802), and wherein the first wall (312), the second wall (314), the third wall (316), the fourth wall (332), the fifth wall (334), and the sixth wall (334) define at least a portion of a rectangular enclosure (304) within the portion (302) of the middle structural layer (802),
wherein the lower structural layer (202) and the middle structural layer (802) are configured to join together to form at least a portion of a storage enclosure (810) capable of storing and funneling bulk materials.

2. The structure of claim 1, wherein the set of lower modules (200) further comprises a third lower module (250) comprising a seventh sloped surface (252), and an eighth sloped surface (254), positioned opposite the seventh sloped surface (252) to form a third partial funnel, wherein the first lower module (210), the second lower module (230), and the third lower module (250) are configured to combine to define the lower structural layer (202), and wherein the third partial funnel defines at least another portion of the whole funnel (204) within the lower structural layer (202).

3. The structure of claim 1, wherein the set of middle modules (300) further comprises:
a third middle module (350) comprising a seventh wall (352); and
a fourth middle module (370) comprising an eighth wall (372),
wherein the first middle module (310), the second middle module (330), the third middle module (350), and the fourth middle module (370) are configured to combine to define the portion (302) of the middle structural layer (802), and wherein the seventh wall (352) and the eighth wall (372) define at least another portion of the rectangular enclosure (304) within the portion (302) of the middle structural layer (802).

4. The structure of claim 3, further comprising:
two additional sets (400, 500) of middle modules, each additional set of middle modules comprising:
a first additional middle module (410, 510) comprising a first additional wall (412, 512), a second additional wall (414, 514), adjacent to the first additional wall (412, 512), and a third additional wall (416, 516), adjacent to the first additional wall (412, 512) and positioned parallel and opposite to the second additional wall (414, 514);
a second additional middle module (430, 530) comprising a fourth additional wall (432, 532), a fifth additional wall (434, 534), adjacent to the fourth additional wall (432, 532), and a sixth additional wall (436, 536), adjacent to the fourth additional wall (432, 532) and positioned parallel and opposite to the fifth additional wall (434, 534);
a third additional middle module (450, 550) comprising a seventh additional wall (452, 552); and
a fourth additional middle module (470, 570) comprising an eighth additional wall (472, 572),
wherein the first additional middle module (410, 510), the second additional middle module (430, 530), the third additional middle module (450, 550), and the fourth additional middle module (470, 570) are configured to combine to define at least an additional portion (402, 502) of the middle structural layer (802), and wherein the first additional wall (412, 512), the second additional wall (414, 514), the third additional wall (416, 516), the fourth additional wall (432, 532), the fifth additional wall (434, 534), the sixth additional wall (436, 536), the seventh additional wall (452, 552), and the eighth additional wall (472, 572) define an additional rectangular enclosure (404, 504) within the middle structural layer (802).

5. The structure of claim 1, further comprising a set of bottom modules (700) comprising:
a first bottom module (710) comprising a first set of supportive struts (712);
a second bottom module (730) comprising a second set of supportive struts (732); and
a third bottom module (750) comprising a platform (752),
wherein the first bottom module (710) and the second bottom module (730) are configured to adjoin the third bottom module (750) opposite each other to define a bottom structural layer (702), wherein the bottom structural layer (702) is configured to join with the lower structural layer (202) to support the storage enclosure (810).

6. The structure of claim 5, wherein the bottom structural layer (702) elevates the storage enclosure by at least 13 feet from the platform (752).

7. The structure of claim 5, wherein the bottom structural layer (702) is configured to accommodate a tractor trailer or a fracking blender between the first set of supportive struts (712) and the second set of supportive struts (732) and below the storage enclosure (810).

8. The structure of claim 5, wherein the bottom structural layer (702) is configured to support the storage enclosure (810) without a physical foundation between the bottom structural layer (702) and the ground.

9. The structural of claim 1, further comprising a set of top modules (600) comprising:
a first top module (610) comprising a first top wall (612), a second top wall (614), adjacent to the first top wall (612), a third top wall (616), adjacent to the first top wall (612) and positioned parallel and opposite to the second top wall (614), and a first roof (618) adjacent to the first top wall (612), the second top wall (614), and the third top wall (616);
a second top module (630) comprising a fourth top wall (632), a fifth top wall (634), adjacent to the fourth top wall (632), a sixth top wall (636), adjacent to the fourth top wall (632) and positioned parallel and opposite to the fifth wall (634), and a second roof (638) adjacent to the fourth top wall (632), the fifth top wall (634), and the sixth top wall (636);
a third top module (650) comprising a seventh top wall (652);
a fourth top module (670) comprising an eighth top wall (672);
a fifth top module (690) comprising a third roof (692),
wherein the first top module (610), the second top module (630), the third top module (650), the fourth top module (670), and the fifth top module (690) are configured to combine to define a top structural layer (602), and wherein the top structural layer (602) is configured to join with the middle structural layer (802) and the lower structural layer (202) to define the storage enclosure (810).

10. The structure of claim 10, wherein at least one of the first roof (618), the second roof (638), and the third roof (692) includes a hatch (620, 640, 694) configured to enable loading of the storage enclosure (810) by conveyor belt, bucket elevator, pneumatic conveyor, or a combination thereof.

11. The structure of claim 1, wherein the storage enclosure (810) has a volume capacity of at least 35,000 cubic feet.

12. A modular bulk materials storage assembly method comprising:
assembling a lower structural layer on a bottom structural layer by:
positioning a first lower module on the bottom structural layer, the first lower module comprising first sloped surfaces that form a first partial funnel;
positioning a second lower module on the bottom structural layer, the second lower module comprising second sloped surfaces that form a second partial funnel;
positioning a third lower module on the bottom structural layer, the third lower module comprising third sloped surfaces that form a third partial funnel;
fastening the first lower module and the second lower module to the third lower module to form the lower structural layer, wherein the first partial funnel, the second partial funnel, and the third partial funnel define a whole funnel; and
attaching the lower structural layer to the bottom structural layer; and
assembling a middle structural layer on the lower structural layer by:
positioning a first middle module on the lower structural layer, the first middle module comprising a first wall, a second wall, adjacent to the first wall, and a third wall, adjacent to the first wall and positioned parallel and opposite to the second wall;
positioning a second middle module on the lower structural layer, the second middle module comprising a fourth wall, a fifth wall, adjacent to the fourth wall, and a sixth wall, adjacent to the fourth wall and positioned parallel and opposite to the fifth wall;
positioning a third middle module on the lower structural layer, the third middle module comprising a seventh wall;
positioning a fourth middle module on the lower structural layer, the fourth middle module comprising an eighth wall;
fastening the first middle module and the second middle module to the third middle module and the fourth middle module to define at least a portion of the middle structural layer, wherein the first wall, the second wall, the third wall, the fourth wall, the fifth wall, the sixth wall, the seventh wall, and the eighth wall define a rectangular enclosure within the middle structural layer; and
attaching the middle structural layer to the lower structural layer to form at least a portion of a storage enclosure capable of storing and funneling bulk materials.

13. The method of claim 12, further comprising:
further assembling the middle structural layer on the lower structural layer by:
positioning a first additional middle module, the first additional middle module comprising a first additional wall, a second additional wall, adjacent to the first additional wall, and a third additional wall, adjacent to the first additional wall and positioned parallel and opposite to the second additional wall;
positioning a second additional middle module, the second additional middle module comprising a fourth additional wall, a fifth additional wall, adjacent to the fourth additional wall, and a sixth additional wall, adjacent to the fourth additional wall and positioned parallel and opposite to the fifth additional wall;
positioning a third additional middle module, the third additional middle module comprising a seventh additional wall;
positioning a fourth additional middle module, the fourth additional middle module comprising an eighth additional wall;
fastening the first additional middle module and the second additional middle module to the third additional middle module and the fourth additional middle module to define at least an additional portion of the middle structural layer, wherein the first additional wall, the second additional wall, the third additional wall, the fourth additional wall, the fifth additional wall, the sixth additional wall, the seventh additional wall, and the eighth additional wall define an additional rectangular enclosure within the middle structural layer.

14. The method of claim 12, further comprising:
assembling the bottom structural layer by:
providing a first bottom module comprising a first set of supportive struts;
providing a second bottom module comprising a second set of supportive struts;
providing a third bottom module comprising a platform; and
fastening the first bottom module and the second bottom module to the third bottom module to form the bottom structural layer, wherein the bottom structural layer is configured to support the storage enclosure.

15. The method of claim 12, further comprising:
assembling a top structural layer by:
positioning a first top module on the middle structural layer, the first top module comprising a first top wall, a second top wall, adjacent to the first top wall, a third top wall, adjacent to the first top wall and positioned parallel and opposite to the second top wall, and a first roof adjacent to the first top wall, the second top wall, and the third top wall;
positioning a second top module on the middle structural layer, the second top module comprising a fourth top wall, a fifth top wall, adjacent to the fourth top wall, a sixth top wall, adjacent to the fourth top wall and positioned parallel and opposite to the fifth wall, and a second roof adjacent to the fourth top wall, the fifth top wall, and the sixth top wall;
positioning a third top module on the middle structural layer, the third top module comprising a seventh top wall;
positioning a fourth top module on the middle structural layer, the fourth top module comprising an eighth top wall;
positioning a fifth top module on the third top module and the fourth top module, the fifth top module comprising a third roof,
fastening the first top module and the second top module to the third top module and the fourth top module and fastening the fifth top module to the third top module and the fourth top module to define a top structural layer, and wherein the top structural layer is configured to join with the middle structural layer and the lower structural layer to define the storage enclosure.
